(19) United States
(12) Patent Application Publication
(10) Pub. No.: US 2023/0011917 A1
(43) Pub. Date: Jan. 12, 2023

(54) INFORMATION PROCESSING APPARATUS, INFORMATION PROCESSING SYSTEM, INFORMATION PROCESSING METHOD, AND NON-TRANSITORY COMPUTER READABLE MEDIUM

(71) Applicant: FUJIFILM Business Innovation Corp., Tokyo (JP)

(72) Inventor: Toshiya NAKAZAWA, Kanagawa (JP)

(73) Assignee: FUJIFILM Business Innovation Corp., Tokyo (JP)

(21) Appl. No.: 17/565,705

(22) Filed: Dec. 30, 2021

(30) Foreign Application Priority Data
Jul. 12, 2021 (JP) 2021-115172

(51) Int. Cl. G06F 3/12

(52) U.S. Cl. CPC G06F 3/1238; G06F 3/1204; G06F 3/1231; G06F 3/1222

(57) ABSTRACT

An information processing apparatus includes a processor configured to: accept a job that provides an instruction for execution of an apparatus function, the job being a delegable job to which a delegation specification is assigned, the delegation specification being used to delegate the execution to a user; and if an apparatus to be operated by the user to execute the delegable job satisfies a predetermined requirement, transmit the delegable job to the apparatus.

### CROSS-REFERENCE TO RELATED APPLICATIONS

This application is based on and claims priority under 35 USC 119 from Japanese Patent Application No. 2021-115172 filed Jul. 12, 2021.

### BACKGROUND

### (i) Technical Field

The present disclosure relates to an information processing apparatus, an information processing system, an information processing method, and a non-transitory computer readable medium.

### (ii) Related Art

There are existing technologies for delegating a job to another user.

Japanese Unexamined Patent Application Publication No. 2018-032140 discloses an information processing apparatus including a process identification information acquiring unit that acquires process identification information in response to a request for execution of a process designated by a process identification code from a delegatee who is to execute the process by proxy through delegation and who has no authority to execute the process, wherein the process identification information at least includes (i) identification information of a delegator which is set corresponding to the process identification code, the delegator allowing the process to be executed by proxy through the delegation, and (ii) an authority given to the delegatee by the delegator on the execution of the process; and a controller that controls the execution of the process in response to the request for the execution from the delegatee according to the authority included in the process identification information acquired by the process identification information acquiring unit.

Japanese Unexamined Patent Application Publication No. 2008-071196 discloses a printing system in which a printer is configured to, in response to a print request from a user, perform a print job received from a user terminal via a network, wherein the user terminal includes an authority-table attachment unit configured to attach a user-execution-authority table to the print job, the user-execution-authority table having a record of user information regarding the user allowed to perform the print job, and the printer includes a print-job storage unit, a print-job search unit, and a display unit, and wherein the print-job storage unit is configured to store in a storage device the print job received from the user terminal, the print-job search unit is configured to refer to the user-execution-authority table attached to the print job based on the user information regarding the user and to search for the print job that the user is allowed to perform, and the display unit is configured to present on a display the print job found by the print-job search unit.

Japanese Unexamined Patent Application Publication No. 2013-246604 discloses an image forming apparatus including a user authenticating unit, an authority-delegation setting unit, and a billing managing unit, wherein the user authenticating unit is configured to perform authenticating processing requested by a first user, the authority-delegation setting unit is configured to set one or more user groups that delegate to a selected user in advance the authority to perform billing, and the billing managing unit is configured to designate at least one user as a user to be billed for image output requested by the first user who has been authenticated, the at least one user belonging to a user group that has delegated to the first user in advance the authority to perform billing.

### SUMMARY

There is an existing technology that enables execution of a user's job to be delegated to another user by assigning a delegation specification to each job. For example, when execution of a job that provides instructions for image formation is delegated by an employee who is working remotely to another employee who is working at the office, a delegation specification is assigned to the job.

A user to whom a job is delegated is entrusted with the task of determining an apparatus with which to do the delegated job. Thus, it is possible that the job is executed by using an apparatus whose security is not maintained.

Aspects of non-limiting embodiments of the present disclosure relate to providing an information processing apparatus, an information processing system, an information processing method, and a non-transitory computer readable medium that are able to restrict execution of a delegated job to an apparatus whose security is maintained.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an information processing apparatus including a processor configured to: accept a job that provides an instruction for execution of an apparatus function, the job being a delegable job to which a delegation specification is assigned, the delegation specification being used to delegate the execution to a user; and if an apparatus to be operated by the user to execute the delegable job satisfies a predetermined requirement, transmit the delegable job to the apparatus.

### BRIEF DESCRIPTION OF THE DRAWINGS

An exemplary embodiment of the present disclosure will be described in detail based on the following figures, wherein:

FIG. 1 depicts a system configuration of an information processing system according to the present exemplary embodiment;

FIG. 2 is a block diagram depicting a hardware configuration of a server according to the present exemplary embodiment;

FIG. 3 is a block diagram depicting a hardware configuration of an image forming apparatus according to the present exemplary embodiment;

FIG. 4 is a block diagram depicting a functional configuration of the server according to the present exemplary embodiment;

FIG. 5 depicts an example of a delegatee-designating screen of a user terminal according to the present exemplary embodiment;

FIG. 6 depicts an example of a job of the information processing system according to the present exemplary embodiment;

FIG. 7 is a flowchart depicting delegable-job accepting processing performed by the server according to the present exemplary embodiment;

FIG. 8 is a flowchart depicting job transmission processing performed by the server according to the present exemplary embodiment;

FIG. 9 depicts an example of a setting value list for the image forming apparatus of the information processing system according to the present exemplary embodiment;

FIG. 10 is a flowchart depicting job execution processing performed by the image forming apparatus according to the present exemplary embodiment;

FIG. 11 depicts an example of a job-list presentation region of the image forming apparatus according to the present exemplary embodiment; and

FIG. 12 is a schematic view for illustrating job handling in the information processing system.

### DETAILED DESCRIPTION

Hereinafter, an exemplary embodiment according to the present disclosure will be described with reference to the drawings. In the drawings, the same or equivalent building components and parts are denoted by the same reference signs. The dimensions and proportions in the drawings are emphasized for the sake of description and are not necessarily drawn to scale.

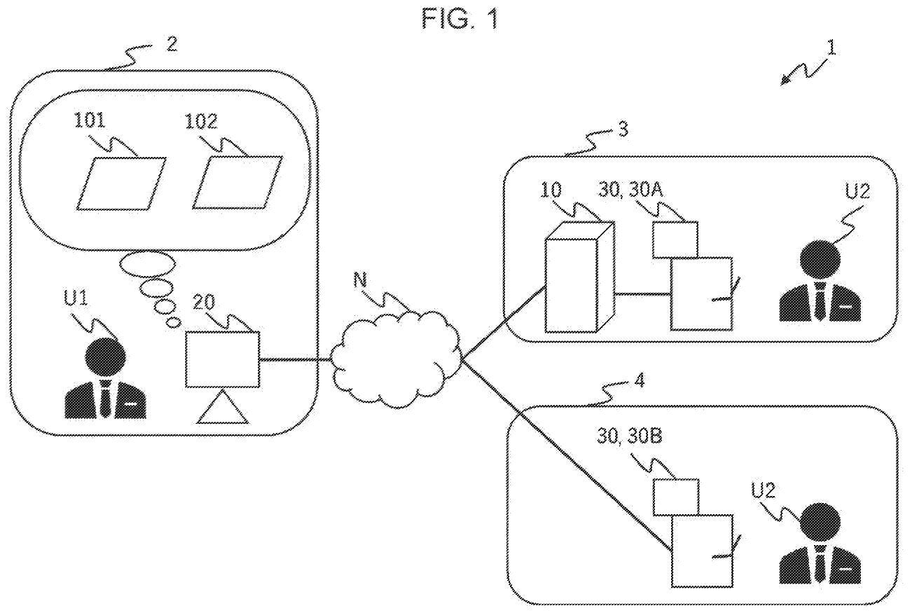

FIG. 1 depicts a system configuration of an information processing system 1 according to the present exemplary embodiment.

The information processing system 1 according to the present exemplary embodiment includes a server 10, which corresponds to an information processing apparatus, a user terminal 20, and multiple apparatuses 30. The server 10, the user terminal 20, and the multiple apparatuses 30 are communicatively connected to each other by using a network N, such as the Internet.

In the present exemplary embodiment, description will be given with regard to an image forming apparatus serving as an apparatus 30, and the reference numeral 30 is used to denote an image forming apparatus. The reference numeral 30 is used to refer to any one of the multiple apparatuses, and reference numerals 30A and 30B are sometimes used to distinguish the multiple apparatuses.

The server 10 manages jobs received from the user terminal 20. A job is a piece of data for providing instructions for executing a function of an image forming apparatus 30 and includes document data subject to processing and setting data specifying settings for the processing. There are two kinds of jobs, a delegable job 101 and a non-delegable job 102. A delegation specification is assigned to a delegable job 101 to delegate execution to another user, and no delegation specification is assigned to a non-delegable job 102. A delegation specification provides information for specifying a user to whom job execution is to be delegated. A delegable job 101 and a non-delegable job 102 are created in the user terminal 20. A user operates an image forming apparatus 30 to execute jobs including a delegable job 101 and a non-delegable job 102.

For example, a user U1 working at a satellite office 2 creates a delegable job 101 or a non-delegable job 102 by using the user terminal 20. The delegable job 101 or the non-delegable job 102, which has been created, is transmitted to and stored in the server 10. If a stored job is the delegable job 101, a user U2 is notified of delegation of the job. The user U2 is designated as a delegatee user for the delegable job 101 by the user U1, who is the delegator user. The user U2 is notified of the delegation, for example, via a user terminal of the user U2, which is not depicted.

In the present exemplary embodiment, the user U2 can use an image forming apparatus 30A disposed inside an office 3 or an image forming apparatus 30B disposed outside the office 3, that is, in an outside location 4.

When the user U2 executes the delegable job 101 on any of the image forming apparatuses 30, the server 10 controls the execution of the delegable job 101.

In the present exemplary embodiment, description will be given with regard to a case where a server is used as an information processing apparatus.

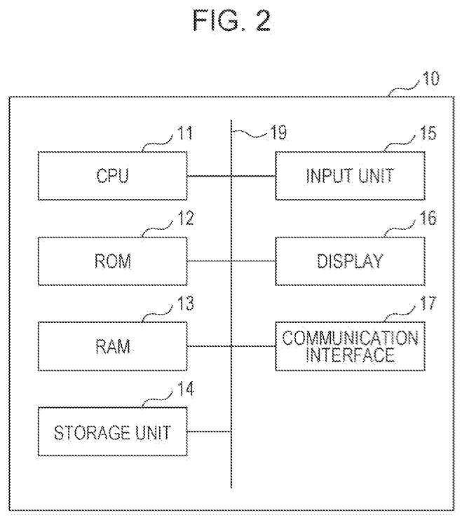

FIG. 2 is a block diagram depicting a hardware configuration of the server 10 according to the present exemplary embodiment. The server 10 includes a central processing unit (CPU) 11, a read-only memory (ROM) 12, a random-access memory (RAM) 13, a storage unit 14, an input unit 15, a display 16, and a communication interface (communication I/F) 17 as components. These components are communicatively connected to each other by using a bus 19.

The CPU 11, which is a central computing processing unit, is configured to execute various programs and control each component. Specifically, the CPU 11 is configured to load programs from the ROM 12 or from the storage unit 14 and use the RAM 13 as a working space to execute the programs. The CPU 11 is configured to control each component described above and perform various kinds of computing processing in accordance with the programs recorded in the ROM 12 or in the storage unit 14. In the present exemplary embodiment, an information processing program configured to accept the delegable job 101 and transmit a job is stored in the ROM 12 or in the storage unit 14.

The ROM 12 is configured to store various programs and various kinds of data. The RAM 13 is configured to function as a working space and temporarily retain programs or data. The storage unit 14 is formed by a hard disk drive (HDD) or a solid-state drive (SSD) and configured to store various programs including the operating system and various kinds of data.

The input unit 15 includes a pointing device, such as a mouse, and a keyboard and is used for receiving various kinds of input. The server 10 may optionally be formed without the input unit 15.

The display 16 is, for example, a liquid crystal display and is configured to present various kinds of information. The display 16 may include a touch panel system and may also function as the input unit 15. The server 10 may optionally be formed without the display 16.

The communication interface 17 is an interface for communicating with another apparatus such as a database, and such a standard as Ethernet (registered trademark), fiber distributed data interface (FDDI), or Wi-Fi (registered trademark) is used.

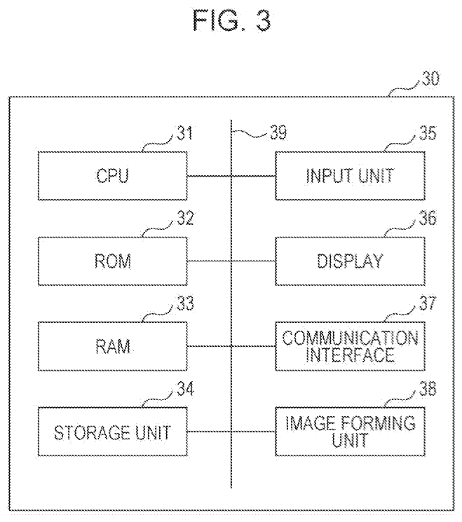

FIG. 3 is a block diagram depicting a hardware configuration of an image forming apparatus 30 according to the present exemplary embodiment. The image forming apparatus 30 includes a CPU 31, a ROM 32, a RAM 33, a storage unit 34, an input unit 35, a display 36, a communication I/F 37, and an image forming unit 38 as components. These components are communicatively connected to each other by using a bus 39.

The CPU 31, which is a central computing processing unit, is configured to execute various programs and control each component. Specifically, the CPU 31 is configured to load programs from the ROM 32 or from the storage unit 34 and use the RAM 33 as a working space to execute the programs. The CPU 31 is configured to control each component described above and perform various kinds of computing processing in accordance with the programs recorded in the ROM 32 or in the storage unit 34. In the present exemplary embodiment, an information processing program configured to present a job list is stored in the ROM 32 or in the storage unit 34.

The ROM 32 is configured to store various programs and various kinds of data. The RAM 33 is configured to function as a working space and temporarily retain programs or data. The storage unit 34 is formed by an HDD or an SSD and configured to store various programs including the operating system and various kinds of data.

The input unit 35 includes a pointing device, such as a mouse, and a keyboard and is used for receiving various kinds of input.

The display 36 is, for example, a liquid crystal display and is configured to present various kinds of information. The display 36 may include a touch panel system and may also function as the input unit 35.

The communication interface 37 is an interface for communicating with another apparatus such as a database, and such a standard as Ethernet (registered trademark), FDDI, or Wi-Fi (registered trademark) is used.

The image forming unit 38 is configured to form imagery on a recording medium, such as a sheet of paper. The imagery is created by a job included in a job list received from the server 10. The imagery is formed by using an electrophotographic system or an inkjet system.

Next, a functional configuration of the server 10 will be described.

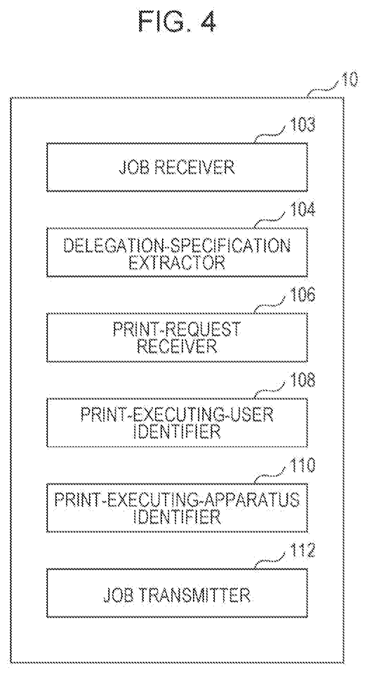

FIG. 4 is a block diagram depicting an example of the functional configuration of the server 10 according to the present exemplary embodiment. The server 10 includes a job receiver 103, a delegation-specification extractor 104, a print-request receiver 106, a print-executing-user identifier 108, a print-executing-apparatus identifier 110, and a job transmitter 112 as functional components. Each functional component is provided by the CPU 11, which reads the information processing program stored in the ROM 12 or in the storage unit 14 and loads the information processing program onto the RAM 13 to execute the program.

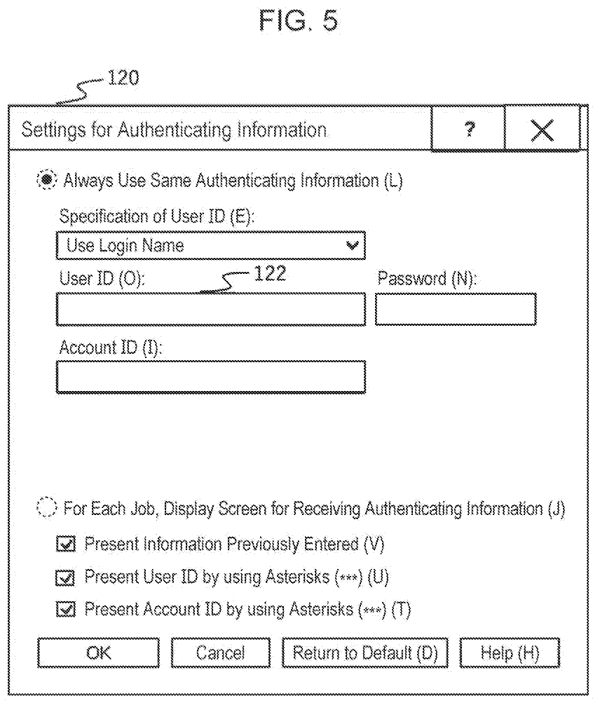

The job receiver 103 accepts a job containing document data from the user terminal 20 operated by the user U1. For example, the job receiver 103 accepts a job that is configured by using a delegatee-designating screen, which will be described below with reference to FIG. 5.

The delegation-specification extractor 104 determines whether a job is a delegable job 101. Specifically, the delegation-specification extractor 104 determines whether a delegation specification has been assigned to a job and identifies the user U2.

The print-request receiver 106 accepts a request to output data to an image forming apparatus 30. Outputting data indicates executing a function of forming imagery based on a job.

The print-executing-user identifier 108 identifies the user U2, who operates an image forming apparatus 30. The print-executing-user identifier 108 identifies the user U2, for example, by acquiring user identification information used by the user U2 to log in to the image forming apparatus 30.

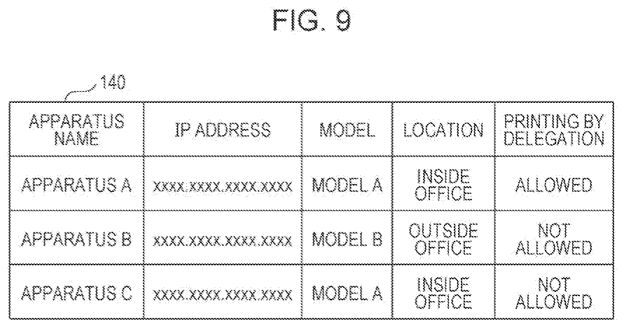

The print-executing-apparatus identifier 110 determines based on the apparatus information regarding an image forming apparatus 30 whether the image forming apparatus 30 is allowed to execute printing by delegation. For example, whether the image forming apparatus 30 is allowed to execute printing by delegation is determined based on an item regarding printing by delegation as described below with reference to FIG. 9. Alternatively, whether the image forming apparatus 30 is allowed to execute printing by delegation may be determined based on such information as network information or location information.

The job transmitter 112 transmits one or more jobs created by the user U2, one or more delegable jobs 101 delegated to the user U2, and a job list in which these jobs are listed. In other words, if the print-executing-apparatus identifier 110 determines affirmatively, the job transmitter 112 adds to a job list for the user U2 one or more delegable jobs 101 to each of which a delegation specification is assigned to designate the user U2 as a delegatee, and the job transmitter 112 transmits the job list. Further, if the print-executing-apparatus identifier 110 determines negatively, the job transmitter 112 adds to a job list for the user U2 no delegable job 101 to which a delegation specification is assigned to designate the user U2 as a delegatee.

FIG. 5 depicts an example of a delegatee-designating screen 120 of the user terminal 20 according to the present exemplary embodiment.

The user terminal 20 transmits a delegable job 101 or a non-delegable job 102 to the server 10 based on an operation by the user U1. The operation is accepted, for example, on the delegatee-designating screen 120, which is a user interface of a printer driver (not depicted) installed on the user terminal 20. The delegatee-designating screen 120 is displayed by the user terminal 20 and has an input box for a delegatee user 122. The user U1 enters user identification information of the user U2 in the input box for a delegatee user 122.

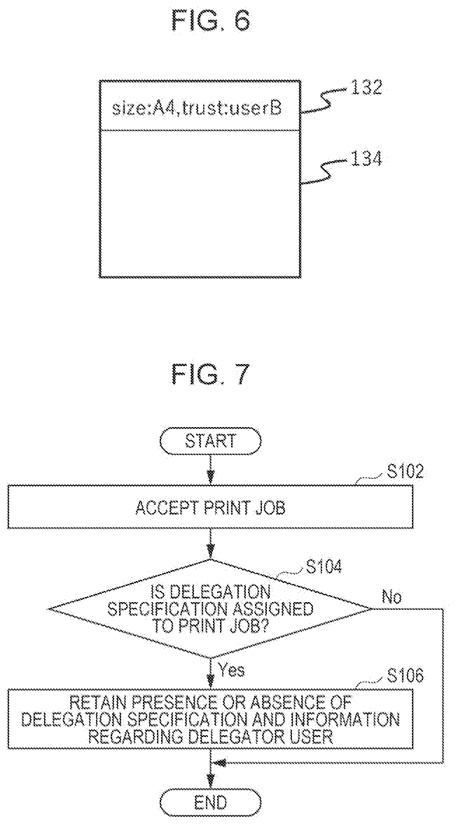

FIG. 6 depicts an example of a job of the information processing system 1 according to the present exemplary embodiment. A job includes a header part 132 and a printing data part 134.

The header part 132 stores metadata such as setting data. The header part 132 stores, for example, setting values for the sheet size and the color. The information processing system 1 may store information regarding the user U2 in the header part 132. For example, if a delegation specification is assigned to designate a user B as a delegatee, the information processing system 1 embeds a character string for identifying a user, such as “trust: user B”, in the header part 132.

The printing data part 134 stores document data from which imagery is formed by the image forming apparatus 30.

Next, an operation of the server 10 will be described.

FIG. 7 is a flowchart depicting delegable-job accepting processing performed by the server 10 according to the present exemplary embodiment. The CPU 11 reads a delegable-job accepting program stored in the ROM 12 or in the storage unit 14 and loads the program onto the RAM 13 to execute the program, and the delegable-job accepting processing is performed.

The CPU 11 accepts a job in step S102. For example, the CPU 11 accepts a job containing document data from the user terminal 20 operated by the user U1. The CPU 11 proceeds to step S104.

The CPU 11 determines in step S104 whether a delegation specification is assigned to the job. If it is determined that a delegation specification is assigned to the job (Yes in step S104), the CPU 11 proceeds to step S106. If it is determined that a delegation specification is not assigned to the job (No in step S104), the CPU 11 terminates the delegable-job accepting processing.

In step S106, the CPU 11 retains presence or absence of a delegation specification and information regarding a delegator user. The CPU 11 terminates the delegable-job accepting processing.

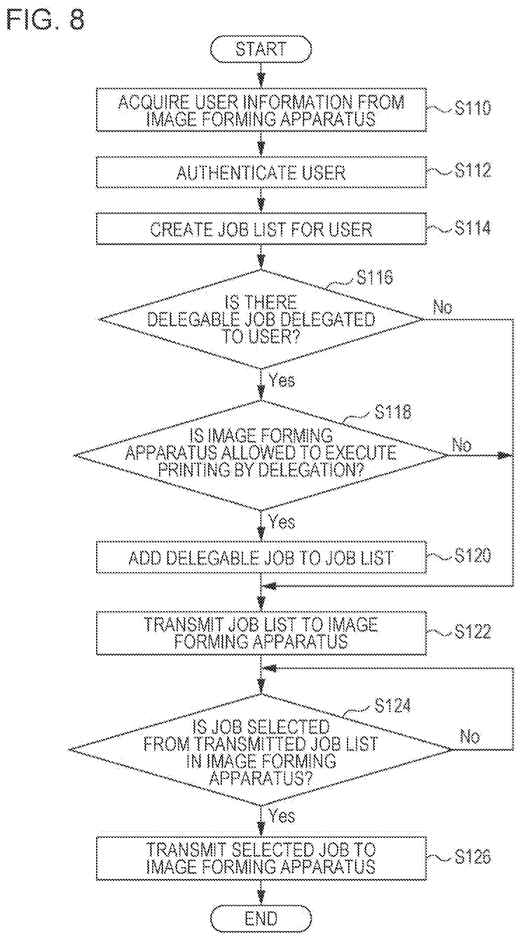

FIG. 8 is a flowchart depicting job transmission processing performed by the server 10 according to the present exemplary embodiment.

The CPU 11 acquires user information from an image forming apparatus 30 in step S110. For example, the CPU 11 receives user identification information of the user U2, who operates the image forming apparatus 30A, from the image forming apparatus 30A. The CPU 11 proceeds to step S112.

The CPU 11 authenticates the user in step S112. The CPU 11 authenticates the user based on the user information that has been received. The CPU 11 proceeds to step S114.

The CPU 11 creates a job list for the user in step S114. The CPU 11 creates as a job list a list of jobs created by the authenticated user. The CPU 11 proceeds to step S116.

The CPU 11 determines in step S116 whether there is a delegable job 101, which is delegated to the user. If it is determined that there is a delegable job 101 delegated to the user (Yes in step S116), the CPU 11 proceeds to step S118. If it is determined that there is no delegable job 101 delegated to the user (No in step S116), the CPU 11 proceeds to step S122.

The CPU 11 determines in step S118 whether the image forming apparatus 30 is allowed to execute printing by delegation. Whether the image forming apparatus 30 is allowed to execute printing by delegation is determined, for example, based on a setting value for an item regarding printing by delegation as described below with reference to FIG. 9. If it is determined that the image forming apparatus 30 is allowed to execute printing by delegation (Yes in step S118), the CPU 11 proceeds to step S120. If it is determined that the image forming apparatus 30 is not allowed to execute printing by delegation (No in step S118), the CPU 11 proceeds to step S122.

The CPU 11 adds the delegable job 101 to the job list in step S120. Specifically, if there is a delegable job 101 to which a delegation specification has been assigned for the authenticated user, the CPU 11 adds the delegable job 101 to the job list for the authenticated user. The CPU 11 proceeds to step S122.

The CPU 11 transmits the job list to the image forming apparatus 30 in step S122. The CPU 11 proceeds to step S124.

The CPU 11 determines in step S124 whether a job is selected in the image forming apparatus 30 from the job list that has been transmitted. Whether a job is selected is determined, for example, based on whether information regarding a selected job is received from the image forming apparatus 30. If a job is not selected from the job list (No in step S124), the CPU 11 waits until a job is selected. If it is determined that a job is not selected for a predetermined period or that presentation of the job list is canceled in the image forming apparatus 30, the CPU 11 may determine that a job will not be selected, stop waiting, and terminate the job transmission processing. If it is determined that a job is selected from the job list (Yes in step S124), the CPU 11 proceeds to step S126.

The CPU 11 transmits the selected job to the image forming apparatus 30 in step S126. Then, the CPU 11 terminates the job transmission processing.

FIG. 9 depicts an example of a setting value list 140 for image forming apparatuses 30 of the information processing system 1 according to the present exemplary embodiment. The setting value list 140 includes such items as “apparatus name”, “IP address”, “model”, “location”, and “printing by delegation”.

The item “apparatus name” represents the name or identification information of an image forming apparatus 30, which corresponds to an apparatus. The item “IP address” represents an IP address assigned to the image forming apparatus 30. The item “model” represents the model number of the image forming apparatus 30. The item “location” represents the location where the image forming apparatus 30 is disposed. The item “printing by delegation” represents a setting value indicating whether execution of a delegable job 101 is allowed. The item “printing by delegation” indicates “allowed” if image formation is allowed for a delegable job 101 and “not allowed” if image formation is not allowed for a delegable job 101. The server 10 may create the setting value list 140 in advance or acquire the setting value list as appropriate.

By checking the item “printing by delegation” in the table in FIG. 9, the CPU 11 determines in step S118 described above whether the image forming apparatus 30 is allowed to execute printing by delegation.

Next, an operation of an image forming apparatus 30 will be described.

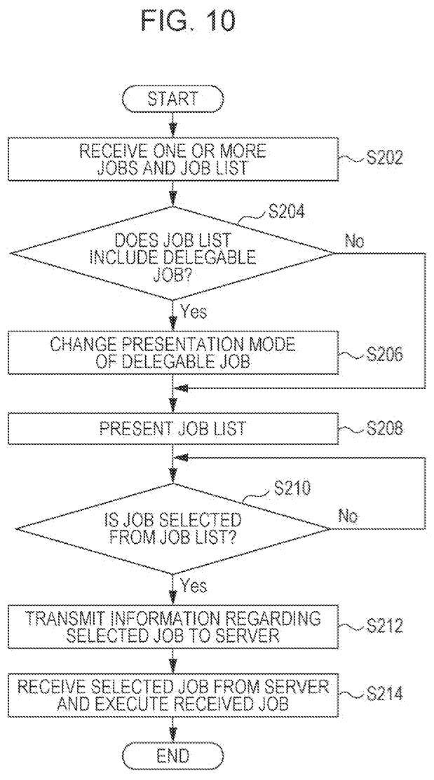

FIG. 10 is a flowchart depicting job execution processing performed by the image forming apparatus 30 according to the present exemplary embodiment. The CPU 31 reads a job-list presentation program stored in the ROM 32 or in the storage unit 34 and loads the program onto the RAM 33 to execute the program, and the job execution processing is performed.

The CPU 31 receives one or more jobs and a job list in step S202. The CPU 31 proceeds to step S204.

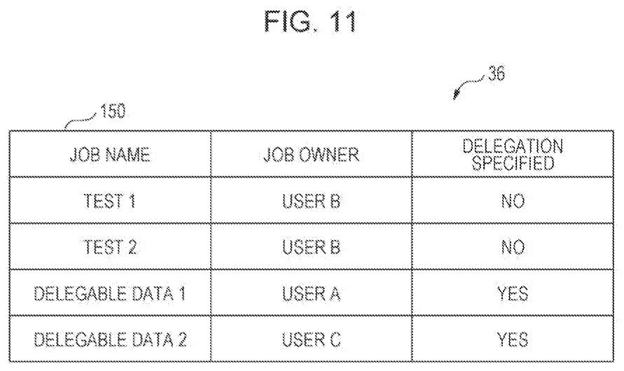

The CPU 31 determines in step S204 whether the job list includes a delegable job 101. Whether the job list includes a delegable job 101 is determined based on presence or absence of a delegation specification as described below with reference to FIG. 11. If it is determined that the job list includes a delegable job 101 (Yes in step S204), the CPU 31 proceeds to step S206. If it is determined that the job list does not include a delegable job 101 (No in step S204), the CPU 31 proceeds to step S208.

In step S206, the CPU 31 changes the presentation mode of the delegable job 101 to a mode that is distinguishable from the mode of a non-delegable job 102. The CPU 31 proceeds to step S208. The presentation mode of the delegable job 101 is changed, for example, by adding the user U1 to the delegable job 101 or by highlighting the delegable job 101.

The CPU 31 presents the job list in step S208. A specific example of the presentation will be described below with reference to FIG. 11. The CPU 31 proceeds to step S210.

The CPU 31 determines in step S210 whether a job is selected from the job list. If a job is not selected (No in step S210), the CPU 31 waits until a job is selected. If it is determined that a job is not selected for a predetermined period or that presentation of the job list is canceled in the image forming apparatus 30, the CPU 31 determines that a job will not be selected, stops waiting, and terminates the job execution processing. The CPU 31 may report to the server 10 that a job will not be selected. If it is determined that a job is selected (Yes in step S210), the CPU 31 proceeds to step S212.

The CPU 31 transmits information regarding the selected job to the server 10 in step S212. The CPU 31 proceeds to step S214.

The CPU 31 receives the selected job from the server 10 and executes the received job in step S214. Then, the CPU 31 terminates the job execution processing.

FIG. 11 depicts an example of a job-list presentation region 150 of an image forming apparatus 30 according to the present exemplary embodiment. The image forming apparatus 30 presents a job list received from the server 10 in the job-list presentation region 150 of the display 36. The job list includes items denoted by “job name”, “job owner”, and “delegation specified”.

The item “job name” represents the name for identifying a job.

The item “job owner” represents the name of a person who has the authority to perform image formation for the job. For a delegable job 101, the user U2 is the job owner. For a non-delegable job 102, a user who has created the job is the job owner.

The item “delegation specified” indicates “yes” for a delegable job 101 and “no” for a non-delegable job 102.

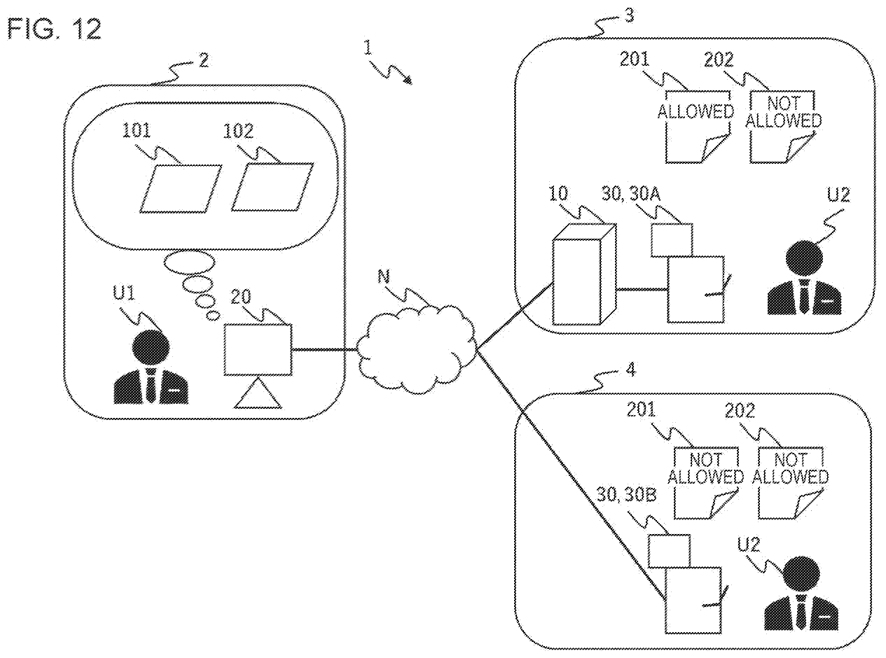

FIG. 12 is a schematic view for illustrating job handling in the information processing system 1.

Whether a delegable job 101 can be executed depends on an image forming apparatus 30 used by the user U2, who is the delegatee, in accordance with the processing described above with reference to FIGS. 8 and 10.

Specifically, the server 10 controls the image forming apparatus 30A, which is disposed in the office 3, so that the user U2 can perform image formation for the delegable job 101 by operating the image forming apparatus 30A. In other words, the image forming apparatus 30A can output a delegable document 201 to be obtained by image formation for the delegable job 101.

In contrast, the server 10 controls the image forming apparatus 30B, which is disposed in the outside location 4, so that the user U2 cannot perform image formation for the delegable job 101 by operating the image forming apparatus 30B. In other words, the image forming apparatus 30B cannot output a delegable document 201 to be obtained by image formation for the delegable job 101.

The server 10 does not allow users other than the user U1 to execute a non-delegable job 102. In other words, neither the image forming apparatus 30A nor the image forming apparatus 30B can output a non-delegable document 202 to be obtained by image formation for the non-delegable job 102.

### Modifications

The information processing system according to the present exemplary embodiment has been described. However, the present disclosure is not limited to the exemplary embodiment described above. Various improvements and modifications are possible.

In step S118 in FIG. 8, the CPU 11 may determine whether an image forming apparatus 30 is allowed to execute printing by delegation based on a predetermined requirement. Specifically, the CPU 11 may transmit a job list and one or more jobs included in the job list to an image forming apparatus 30 that satisfies a predetermined requirement. The CPU 11 may make a determination as described below based on the items “apparatus name”, “model”, “IP address”, or “location”, which are depicted in FIG. 9.

For example, if positional information indicates that an image forming apparatus 30 is disposed within a predetermined region, the CPU 11 determines that the image forming apparatus 30 is allowed to execute printing by delegation. Specifically, for example, if positional information indicates that an image forming apparatus 30 is disposed within a predetermined region around the location of the office 3, the CPU 11 determines that the image forming apparatus 30 is allowed to execute printing by delegation. The information processing system 1 may acquire the positional information regarding the placement location in advance or may acquire the positional information from the global positioning system (GPS) installed on an image forming apparatus 30.

In addition, for example, if the apparatus name or the model number of an image forming apparatus 30 has been registered in advance, the CPU 11 determines that the image forming apparatus 30 is allowed to execute printing by delegation.

Further, for example, if the network information of an image forming apparatus 30 is within a predetermined range, the CPU 11 determines that the image forming apparatus 30 is allowed to execute printing by delegation. Specifically, if the IP address of an image forming apparatus 30 is within a predetermined range, the CPU 11 determines that the image forming apparatus 30 is allowed to execute printing by delegation. Further, if the network to which an image forming apparatus 30 belongs is the same network to which the user terminal 20 or the server 10 belongs, the CPU 11 determines that the image forming apparatus 30 is allowed to execute printing by delegation.

In steps S206 and S208 in FIG. 10, the CPU 31 may present a job list in a presentation mode created by the server 10. In other words, the server 10 may create a presentation mode of a job list to be presented by an image forming apparatus 30 and transmit the presentation mode to the image forming apparatus 30.

The processing described above may also be achieved by using dedicated hardware circuitry. In such a case, a piece of hardware may perform the processing, or multiple pieces of hardware may perform the processing.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

The programs configured to operate the server 10 and the image forming apparatuses 30 may be provided by using a computer readable recording medium, such as a universal-serial-bus (USB) memory, a flexible disc, or a compact disc read-only memory (CD-ROM), or may be provided online via a network, such as the Internet. In such cases, the programs recorded in a computer readable recording medium are typically transferred to and stored in a memory or a storage unit. Further, for example, these programs may be provided as stand-alone application software or may be built into software for the server 10 or the image forming apparatuses 30 as a function of each apparatus.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing apparatus comprising:
a processor configured to:
accept a job that provides an instruction for execution of an apparatus function, the job being a delegable job to which a delegation specification is assigned, the delegation specification being used to delegate the execution to a user; and
if an apparatus to be operated by the user to execute the delegable job satisfies a predetermined requirement, transmit the delegable job to the apparatus.

2. The information processing apparatus according to claim 1,
wherein the predetermined requirement is that the apparatus to be operated by the user is allowed to execute a delegable job.

3. The information processing apparatus according to claim 1,
wherein the predetermined requirement is that the apparatus to be operated by the user is disposed within a predetermined region or that information regarding a network to which the apparatus is connected is within a predetermined range.

4. The information processing apparatus according to claim 2,
wherein the predetermined requirement is that the apparatus to be operated by the user is disposed within a predetermined region or that information regarding a network to which the apparatus is connected is within a predetermined range.

5. The information processing apparatus according to claim 1,
wherein the predetermined requirement is that identification information or a model number of the apparatus to be operated by the user is registered in advance.

6. The information processing apparatus according to claim 2,
wherein the predetermined requirement is that identification information or a model number of the apparatus to be operated by the user is registered in advance.

7. The information processing apparatus according to claim 3,
wherein the predetermined requirement is that identification information or a model number of the apparatus to be operated by the user is registered in advance.

8. The information processing apparatus according to claim 4,
wherein the predetermined requirement is that identification information or a model number of the apparatus to be operated by the user is registered in advance.

9. An information processing system comprising:
the information processing apparatus according to claim 1; and
the apparatus,
wherein the apparatus includes:
a display; and
a second processor configured to:
cause the display to present the delegable job in a mode that makes the delegable job distinguishable from a job accepted from the user.

10. An information processing system comprising:
the information processing apparatus according to claim 2; and
the apparatus,
wherein the apparatus includes:
a display, and
a second processor configured to:
cause the display to present the delegable job in a mode that makes the delegable job distinguishable from a job accepted from the user.

11. An information processing system comprising:
the information processing apparatus according to claim 3; and
the apparatus,
wherein the apparatus includes:
a display, and
a second processor configured to:
cause the display to present the delegable job in a mode that makes the delegable job distinguishable from a job accepted from the user.

12. An information processing system comprising:
the information processing apparatus according to claim 4; and
the apparatus,
wherein the apparatus includes:
a display, and
a second processor configured to:
cause the display to present the delegable job in a mode that makes the delegable job distinguishable from a job accepted from the user.

13. An information processing system comprising:
the information processing apparatus according to claim 5; and
the apparatus,
wherein the apparatus includes:
a display, and
a second processor configured to:
cause the display to present the delegable job in a mode that makes the delegable job distinguishable from a job accepted from the user.

14. An information processing system comprising:
the information processing apparatus according to claim 6; and
the apparatus,
wherein the apparatus includes:
a display, and
a second processor configured to:
cause the display to present the delegable job in a mode that makes the delegable job distinguishable from a job accepted from the user.

15. An information processing system comprising:
the information processing apparatus according to claim 7; and
the apparatus,
wherein the apparatus includes:
a display, and
a second processor configured to:
cause the display to present the delegable job in a mode that makes the delegable job distinguishable from a job accepted from the user.

16. An information processing system comprising:
the information processing apparatus according to claim 8; and
the apparatus,
wherein the apparatus includes:
a display, and
a second processor configured to:
cause the display to present the delegable job in a mode that makes the delegable job distinguishable from a job accepted from the user.

17. The information processing system according to claim 9,
wherein the mode that makes the delegable job distinguishable involves presenting the delegable job along with information regarding a user who has assigned the delegation specification to the delegable job.

18. The information processing system according to claim 10,
wherein the mode that makes the delegable job distinguishable involves presenting the delegable job along with information regarding a user who has assigned the delegation specification to the delegable job.

19. A non-transitory computer readable medium storing a program causing a computer to execute a process for information processing, the process comprising:
accepting a job that provides an instruction for execution of an apparatus function, the job being a delegable job to which a delegation specification is assigned, the delegation specification being used to delegate the execution to a user; and
if an apparatus to be operated by the user to execute the delegable job satisfies a predetermined requirement, transmitting the delegable job to the apparatus.

20. An information processing method comprising:
accepting a job that provides an instruction for execution of an apparatus function, the job being a delegable job to which a delegation specification is assigned, the delegation specification being used to delegate the execution to a user; and
if an apparatus to be operated by the user to execute the delegable job satisfies a predetermined requirement, transmitting the delegable job to the apparatus.
